(19) United States
(12) Patent Application Publication
(10) Pub. No.: US 2025/0280252 A1
(43) Pub. Date: Sep. 4, 2025

(54) METHODS AND APPARATUSES FOR AUTOMATIC GAIN CONTROL OF AN AUDIO SIGNAL

(71) Applicant: Shure Acquisition Holdings, Inc., Niles, IL (US)

(72) Inventors: Ross Penniman, Morton Grove, IL (US); Stefan Hopman, Evanston, IL (US)

(21) Appl. No.: 19/054,149

(22) Filed: Feb. 14, 2025

Related U.S. Application Data
(60) Provisional application No. 63/559,262, filed on Feb. 29, 2024.

(51) Int. Cl. H04R 29/00; H04R 3/00

(52) U.S. Cl. CPC H04R 29/001; H04R 3/00

(57) ABSTRACT

Methods, apparatuses, and algorithms for the automatic control of gain applied to, or associated with, an audio signal are described herein. An example method may comprise generating a first amplitude measurement of an audio signal, generating a second amplitude measurement of the audio signal, determining a first difference between the first amplitude measurement and the second amplitude measurement; generating, based on the first difference, a first indication; calculating, based on at least the first indication, a target gain; and modifying, based on the target gain, a gain state associated with the first audio signal according to a first ramp speed.

### CROSS-REFERENCE TO RELATED APPLICATIONS

The present application claims priority to U.S. Provisional Patent Application No. 63/559,262, filed Feb. 29, 2024, which is incorporated by reference in its entirety.

### FIELD

Aspects described herein generally relate to audio signal processing, and/or hardware and/or software related thereto. More specifically, one or more aspects described herein provide for the automatic control of gain applied to a microphone signal.

### BACKGROUND

In many instances, podcasters, broadcasters, audio streamers, recording artists, sound engineers, and the like may wish to have a stable microphone signal output level irrespective of whether the user is talking softly or loudly into the microphone to minimize unnatural voice fluctuations and pumping of background noise. Background noise pumping may refer to unpredictable (and often drastic) changes in the gain applied to an audio signal as a result of the background noise triggering signal processors to adjust the gain. Users may also wish to utilize automatic gain control solutions that are not microphone (or hardware) dependent.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

As described in more detail herein, this application sets forth apparatuses, methods, and algorithms for automatically calculating a gain value to apply to an audio system, which may include one or more microphones, to meet a desired output level. This application further sets forth apparatuses, methods, and algorithms for automatically estimating microphone sensitivity and offsetting said sensitivity.

An example apparatus may comprise an audio detector. The audio detector may be configured to receive a first audio signal having a first signal level. The audio detector may comprise one or more envelope followers and comparators. The one or more envelope followers may comprise a plurality of envelope followers that may comprise a first envelope follower, a second envelope follower, and a third envelope follower. The first envelope follower may be configured to generate, from a first audio signal and based on a first time constant, a first amplitude measurement. The second envelope follower may be configured to generate, from the first audio signal and based on a second time constant different from the first time constant, a second amplitude measurement. The third envelope follower may be configured to generate, from the first audio signal and based on a third time constant different from the first time constant and the second time constant, a third amplitude measurement. A first comparator may be configured to output a difference between the outputs of the first and second envelope followers. A second comparator may be configured to generate a first indication of whether the output of the first comparator satisfies a first threshold value. A third comparator may be configured to output a difference between the outputs of the first and third envelope followers. A fourth comparator may be configured to generate a second indication of whether the output of the third comparator satisfies a threshold value. The apparatus may comprise a gain control subsystem in communication with the audio detector. The gain control subsystem may comprise a target gain calculation module and gain state update module. The target gain calculation module may be configured to calculate, based on at least one or more of the first and second indications, a target gain for the audio signal. The gain state update module may be configured to modify, based on the target gain, a gain state applied to, or associated with, the audio signal.

An example method may comprise generating, by a computing device, a first amplitude measurement of an audio signal based on a first time constant; generating, from the first audio signal and based on a second time constant different from the first time constant, a second amplitude measurement; generating, from the first audio signal and based on a third time constant different from the first and second time constants, a third amplitude measurement; outputting a first difference between the first amplitude measurement and the second amplitude measurement; generating a first indication of whether the first difference satisfies a first threshold value; outputting a second difference between the first amplitude measurement and the third amplitude measurement; generating a second indication of whether the second difference satisfies a second threshold value; calculating, based on at least one or more of the first and second indications, a target gain for the first audio signal; and modifying, based on the target gain, a gain state of the system to apply to the audio signal. The method may further comprise modifying the gain state based on a hysteresis of the first target gain. The method may further comprise modifying the gain state of the first audio signal according to a ramp speed. The ramp speed may be based on a difference between the target gain and gain state.

These as well as other novel advantages, details, examples, features and objects of the present disclosure will be apparent to those skilled in the art from following the detailed description, the attached claims and accompanying drawings, listed herein, which are useful in explaining the concepts discussed herein.

### BRIEF DESCRIPTION OF THE DRAWINGS

Some features are shown by way of example, and not by limitation, in the accompanying drawings. In the drawings, like numerals reference similar elements.

FIG. 1 illustrates an example network architecture that may be used to implement one or more illustrative aspects described herein.

FIG. 2 illustrates an example system architecture that may be used to implement one or more illustrative aspects described herein.

FIG. 3a illustrates a block diagram of an example automatic gain control module.

FIG. 3b illustrates a block diagram of a subsystem of the example automatic gain control module of FIG. 3a.

FIG. 3c illustrates an example input/output curve of the example automatic gain control module of FIG. 3a.

FIG. 4 illustrates an example hysteresis gain ramp speed plot.

FIG. 5 illustrates an example flow chart of a method that may be performed to implement one or more illustrative aspects described herein.

FIG. 6 illustrates another example gain control module.

### DETAILED DESCRIPTION

In the following description of the various examples, reference is made to the accompanying drawings, which form a part hereof, and in which is shown by way of illustration various examples in which aspects may be practiced. References to “embodiment,” “example,” and the like indicate that the embodiment(s) or example(s) of the invention so described may include particular features, structures, or characteristics, but not every embodiment or example necessarily includes the particular features, structures, or characteristics. Further, it is contemplated that certain embodiments or examples may have some, all, or none of the features described for other examples. And it is to be understood that other embodiments and examples may be utilized and structural and functional modifications may be made without departing from the scope of the present disclosure.

Unless otherwise specified, the use of the serial adjectives, such as, “first,” “second,” “third,” and the like that are used to describe components, are used only to indicate different components, which can be similar components. But the use of such serial adjectives is not intended to imply that the components must be provided in given order, either temporally, spatially, in ranking, or in any other way.

Also, while the terms “front,” “back,” “side,” and the like may be used in this specification to describe various example features and elements, these terms are used herein as a matter of convenience, for example, based on the example orientations shown in the figures and/or the orientations in typical use. Nothing in this specification should be construed as requiring a specific three dimensional or spatial orientation of structures in order to fall within the scope of the claims.

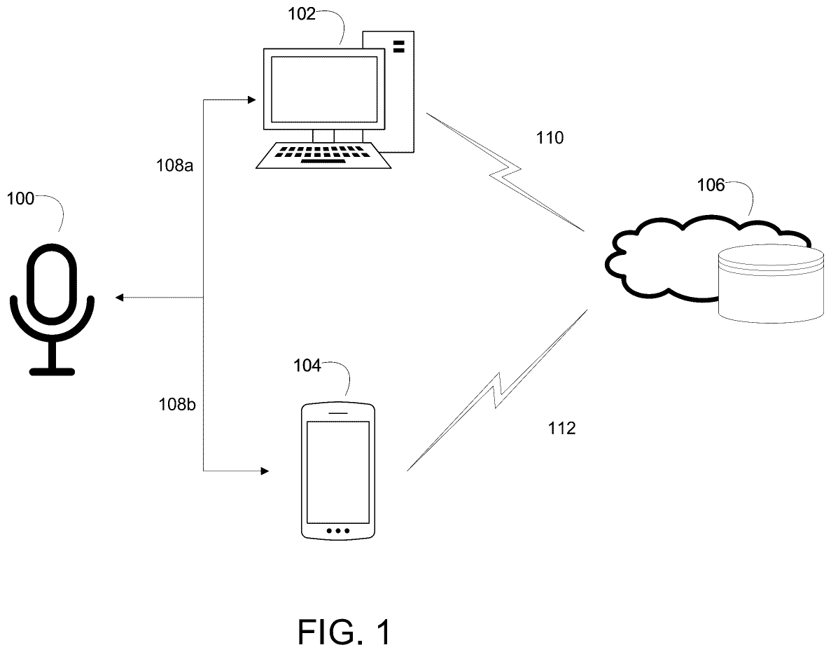

FIG. 1 illustrates an example of a network architecture that may be used to implement one or more illustrative aspects described herein in a standalone and/or networked environment. Device 100 may be a microphone, including any number of microphone types, such as a condenser microphone (e.g., including large-and small-diaphragm and electret condenser), a dynamic microphone (e.g., including moving coil and ribbon microphones), or a MEMS microphone, among others. Device 100 may be a smartphone microphone (such as that of smartphone 104), a desktop or laptop microphone (such as that of device 102), a headset microphone, a two-way radio microphone, or any other microphone that may be connected to and/or in communication with a device (such as devices 102 and 104). Device 100 may be a component of a wireless microphone system, such as, for example, a wireless transmitter, a wireless receiver, or a wireless transceiver. Device 100 may be any number of audio interfaces. Any one or more of devices 100, 102, 104, and 106 may be any type of known computer or server. Device 102 may be a desktop computer. Device 104 may be a smartphone or tablet. Devices 102 and 104 may include a user interface, including a graphical user interface, to allow a user to interact with the system. Device 106 may be a data server, including a cloud-based data server. Devices 100, 102, 104, and 106 may be interconnected via wide area network (WAN), such as the Internet. Other networks may also or alternatively be used, including local area networks (LAN), wireless networks, personal networks (PAN), and the like. Devices 100, 102, 104, and 106 and other devices (not shown) may or might not be communicatively connected to one or more of the networks via twisted pair wires, coaxial cable, fiber optics, radio waves, or other communication media. Device 100 may be communicatively connected to device 102 and/or device 104 via connections 108a and/or 108b, respectively. Device 102 may be communicatively connected to device 106 via connection 110 and device 104 may be communicatively connected to device 106 via connection 112.

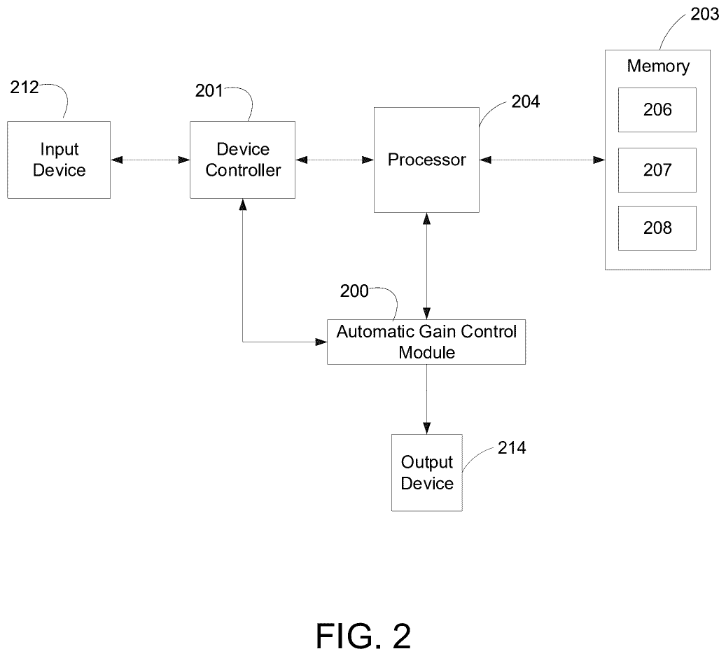

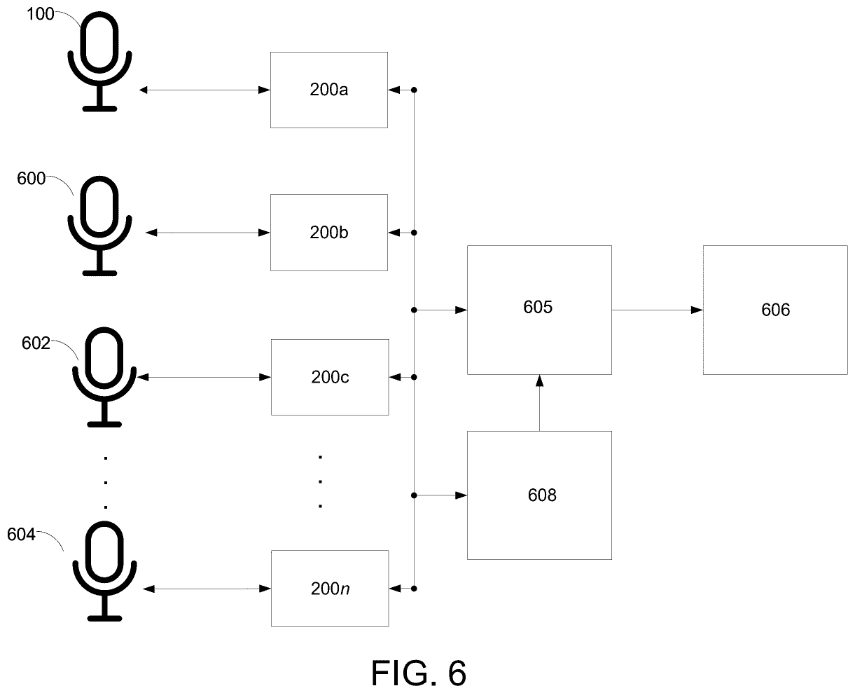

FIG. 2 illustrates an example of a system architecture that may be used to implement one or more illustrative aspects described herein. One or more of automatic gain control modules 200, 200a, 200b, 200c, 200n (hereinafter collectively referred to as “the gain control modules”) (gain control modules 200a, 200b, 200c, 200n described in greater detail in FIG. 6) may be implemented as (or controllable by) a processor 204. Individual reference to gain control module 200 and/or 200a, 200b, 200c, 200n may also apply to any gain control module(s) not explicitly referenced. For the sake of simplicity, and except where otherwise noted, reference to gain control module 200 shall include gain control modules 200a, 200b, 200c, 200n, and vice versa.

Processor 204 may be communicatively connected to memory 203. The memory 203 may store operating system software 206 for controlling overall operation of the gain control modules and/or control logic 207 for instructing the gain control modules to perform aspects described herein. Some or all of the aspects described herein may be performed by firmware applications intended to run without an operating system, such as, for example, an ASIC, or a DSP chip configured to perform the operations described natively or by the control of an operating system, etc. Functionality of the control logic 207 may refer to operations or decisions made automatically based on rules coded into the control logic 207, made manually by a user providing input into the system, and/or a combination of automatic processing based on user input (e.g., queries, data updates, user-selected modes, a list of input devices previously setup with the software application, etc.). Memory 203 may store data used in performance of one or more aspects described herein, including at least one database 208. Memory may also store other data. For example, where the memory 203 is part of, for example, the input device 212, such as device 100, the memory may store its operating system and/or the software application that performs aspects described herein, user preferences such as preferred modes, a list of input devices (such as device 100, among others) previously setup with the software application, communication protocol settings, and/or data supporting any other functionality of the input device 212.

One or more aspects may be embodied in computer-usable or readable data and/or computer-executable instructions, such as in one or more program modules, executed by one or more computers or other devices as described herein, such as processor 204. Generally, program modules include routines, programs, objects, components, data structures, etc. that perform particular tasks or implement particular abstract data types when executed by a processor in a computer or other device. The modules may be written in a source code programming language that is subsequently compiled for execution, such as, for example, C, C++, and/or Assembly, or may be written in a scripting language such as (but not limited to) Python, Perl, PHP, Ruby, JavaScript, and the like. The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, some or all of the functionalities performed by the gain control modules may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

With further reference to FIGS. 1 and 2, one or more of the gain control modules may be embodied in any one or more of devices 100, 102, 104, and/or 106, as well as (or alternatively) in one or more additional devices (not shown). One or more of the gain control modules, device controller 201, memory 203, processor 204, output device 214, and/or input device 212 may be embodied in any one or more of devices 100, 102, 104, and/or 106, as well as (or alternatively) in one or more additional devices (not shown). Aspects described herein may be operational with numerous other general purpose and/or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, supercomputers configured to run online application programming interfaces (APIs), distributed computing environments that include any of the above systems or devices, and the like. The gain control modules may be implemented as embedded software running in, for example, device 100, and executable on processor 204. The gain control modules may be implemented as an external signal processor, such as a hardware DSP module, a real-time software processor, an offline software processor, or a software plug-in (including VST, AU, and AAX formats). The gain control modules may include several states, including an always-active state and an on/off state based on a user's input. In the always-active state, the gain control modules may be implemented as a VST plugin. The VST may be inserted into a digital audio workstation (“DAW”) to actively monitor an incoming audio signal. One or more of the gain control modules may be implemented as software or a plugin compatible with one or more video communications platforms, video streaming platforms, audio communications platforms, and/or audio streaming platforms.

As shown in FIG. 2, input device 212 (such as device 100) may be in communication with device controller 201. Device controller 201 may facilitate interaction from input device 212 to one or more of the gain control modules. Analog and/or digital audio may be transmitted from input device 212 to device controller 201. Digital data may be transmitted bidirectionally (from input device 212 to device controller 201, and/or from device controller 201 to input device 212). Input device 212 may include, for example, one or more universal serial bus (USB) connectors, one or more XLR connectors, one or more power connectors, and/or any other type of data and/or power connectors suitable for transporting signals such as power, digital data (including digital audio signals), and/or analog audio signals to and from input device 212. Where the connection is wired, device controller 201 may further comprise a data interface (not shown) for communicating with input device 212. For example, the data interface may comprise a USB interface or an XLR interface. While several wired connections are discussed between device controller 201 and input device 212, other types of wired or wireless connections may be used. For example, the connection between device controller 201 and input device 212 may instead be a wireless connection, such as a Wi-Fi connection or other proprietary wireless connection protocols, a Bluetooth connection, a near-field connection (NFC), and/or an infrared connection. Where the connection is wireless, device controller 201 and input device 212 may include a wireless communications interface.

As has been discussed, users may wish to have a stable microphone signal output level irrespective of whether the user is talking softly or loudly into the microphone to minimize unnatural voice fluctuations and pumping of background noise. Users may also wish to utilize automatic gain control solutions that are not microphone (or hardware) dependent. At least some problems may arise with some gain control algorithms, such as, for example, drastic changes in the applied gain when there has not been a significant change in user activity. These drastic changes in gain may result in unwanted expansion behavior and, as previously mentioned, background noise (e.g., noise floor) pumping. Other shortcomings with some gain control algorithms may arise, such as, for example, deficiencies in fully matching the input level signal to a desired output level, a hardware dependent gain input/output (“I/O”) curve (which may lead to varying performance of the algorithm based on the microphone the user is talking into), and an overly active limiter (which may distort the audio signal). As described herein, automatic gain control may be improved with an automatic gain control module that may be configured to, for example: 1) appropriately adjust the gain applied to, or associated with, an audio system by a sufficient amount that prevents expansion-like behavior and noise floor pumping, by, for example, utilizing a hysteresis to adjust a signal level; 2) consistently achieve a desired output level irrespective of the loudness of a user's voice; 3) exhibit hardware-independence; and 4) estimate the effective sensitivity of a microphone and apply an offset gain to the microphone signal.

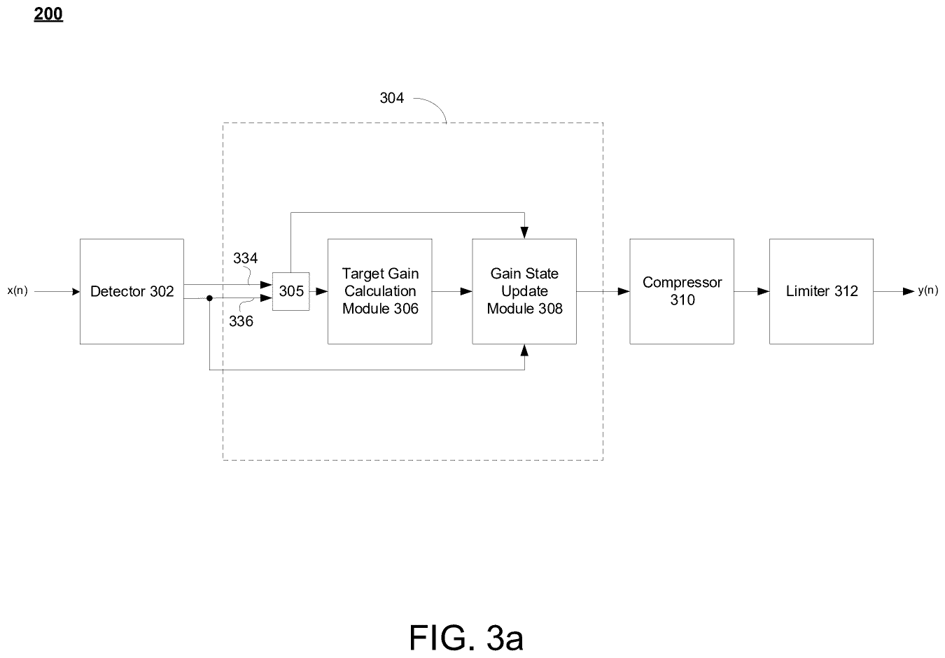

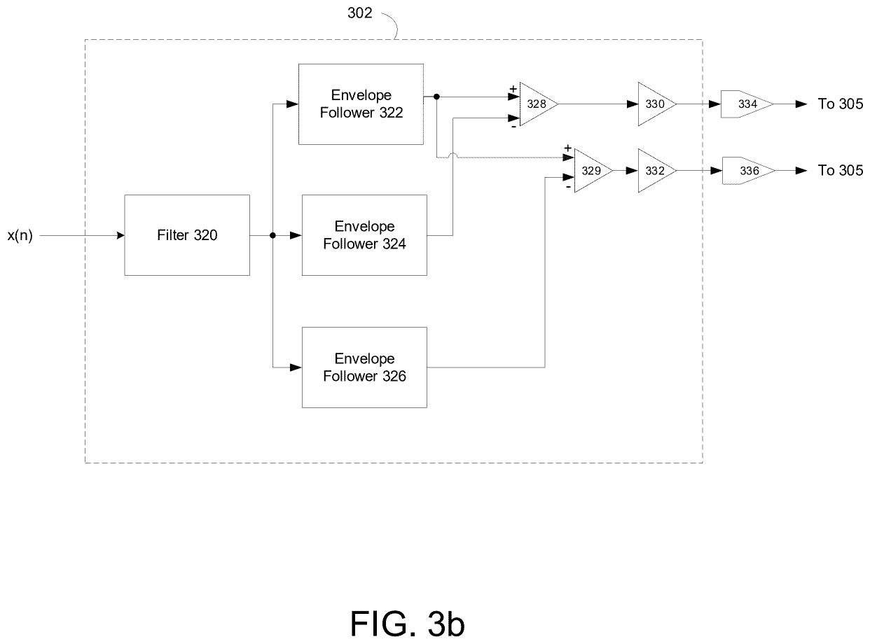

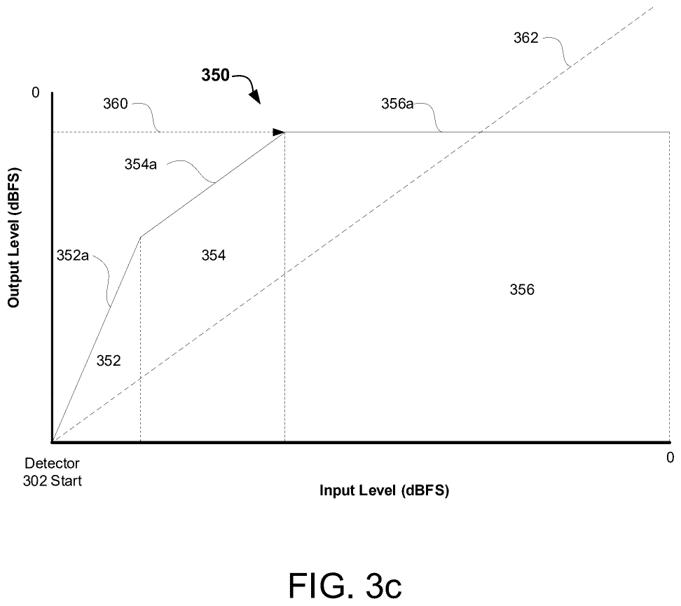

As shown in FIG. 3a, gain control module 200 may include audio detector 302 (hereinafter referred to as “detector 302”) and gain control subsystem 304 (hereinafter referred to as “subsystem 304”). Detector 302 may be configured as many types of detectors, such as, for example, a voice activity detector (“VAD”). Detector 302 may be implemented in any number of manners, such as, for example, an energy-based VAD or a cepstral VAD. Detector 302 may be configured to receive audio signal x(n) and detect, for example, the presence of human speech. Detector 302 may be configured to output one or more indications 334, 336 to subsystem 304. Detector 302 is further described in FIG. 3b.

Subsystem 304 may include comparator 305. As with comparators 328, 328, 330, 332, comparator 305 may be embodied in whole or in part in software, firmware, and/or hardware or hardware equivalents such as integrated circuits, an FPGA chip, and the like. Comparator 305 may be configured to receive one or more of indications 334, 336 from detector 302 and generate an output to target gain calculation module 306 and gain state update module 308 based on the state of one or more of indications 334, 336. Comparator 305 may be communicatively coupled with gain state update module 308. Comparator 305 may generate an output to gain state update module 308 based on the state of one or more of indications 334, 336. Indications 334 and 336 may generally instruct subsystem 304 to recalculate the target gain. Indication 336 may generally instruct subsystem 304 to adjust a gain state to move the gain state toward an incumbent target gain or a recalculated target gain. Indications 334, 336 may be represented as Boolean data (e.g., having a “true” state and a “false” state, or a value of “1” or “0”, respectively).

Indications 334, 336 may be represented as other forms of data, such as, for example, continuous quantitative variables, multi-level logic, a voltage, a pulse signal, etc. Indications 334, 336 may be represented as other forms of data that generally indicate whether one or more conditions, etc., have been met. Comparator 305 may be implemented in various manners, including, for example, as a Boolean operator. Based on the output of comparator 305, target gain calculation module 306 may recalculate a target gain according to aspects described herein. For example, if both indications 334, 336 are “true” (e.g., value of “1”), the output of comparator 305 may instruct target gain calculation module 306 to recalculate target gain and gain state update module 308 to adjust the gain state toward the incumbent target gain or recalculated target gain. If indication 334 is “false” (e.g., value of “0”), but indication 336 is true, the output of comparator 305 may instruct gain state update module 308 to adjust the gain state toward the incumbent target gain or recalculated target gain.

As discussed, subsystem 304 may include target gain calculation module 306 and gain state update module 308 (also referred to as “update module 308”). Target gain calculation module 306 may include Input/Output Curve 350 (described in greater detail in FIG. 3c) (hereinafter referred to as “curve 350”). Target gain calculation module 306 may be configured to implement curve 350 to calculate the target gain. The structure of curve 350 may be chosen to help reduce the impact of background noise, such as, for example, background noise coming from background talkers.

Update module 308 may be configured to receive an output from target gain calculation module 306 and an output of indication 336 from detector 302. Update module 308 may be configured to modify a gain state of the system and/or the rate by which to adjust the gain state of the system toward a target gain. The output of indication 336 from detector 302 may be represented as Boolean data. The output of target gain calculation module 306 may be represented as non-Boolean data, such as, for example, a value represented as decibels (dB), decibels relative to full scale (dBFS), decibel Volt (dBV), sound pressure level (dB SPL), and the like. Update module 308 may be configured to apply one or more smoothing functions to the output of target gain calculation module 306 to help minimize the presence of transient artifacts in the signal that may arise from abrupt changes in gain. The smoothing function of update module 308 may be a linear, exponential, or other non-linear curve between the current gain state of update module 308 and the target gain as determined by target gain calculation module 306. The output generated by update module 308 may reflect a smooth transition between an “adjust” state and an “inactive” state. Gain state update module 308 may transition between these states any number of times (e.g., for a fixed number of times or indefinitely).

Automatic gain control module 200 may include compressor 310 and limiter 312. Compressor 310 may be configured to receive an output signal from update module 308 and perform further processing on the audio signal, such as, for example, compression of the signal x(n). Compressor 310 may be configured to provide a compressed audio signal to limiter 312. Compressor 310 and/or limiter 312 may be configured with a number of thresholds and ratios. Limiter 312 may be configured, for example, as a full-band limiter or a multi-band limiter. Limiter 312 may further process the gain-corrected signal x(n) and provide a signal y(n) for further processing and/or for output via an output device such as, for example, output devices 214 and/or 606 (described with respect to FIG. 6). An audio output device, such as output device 606 (discussed in greater detail with respect to FIG. 6), may receive output signal y(n) for further processing or for playback.

FIG. 3b illustrates detector 302 in greater detail. Detector 302 may be configured to receive an analog and/or digital signal x(n). Detector 302 may include filter 320; envelope followers 322, 324, 326; comparators 328, 329; and comparators 330, 332. Filter 320 may be any number of types of filters, including, but not limited to, minimum phase, linear phase, feed-forward, feed-back, bandpass, etc. Filter 320 may have a passband between 50 and 5000 Hz (or some other frequency range). Filter 320 may have a passband between more or less than 50 Hz (e.g., 1 Hz, 20 Hz, 60 Hz) and more or less than 5000 Hz (e.g., 5500 Hz, 6000 Hz, 7500 Hz, up to the highest-supported frequency of the system, etc.).

Filter 320 may provide a filtered input signal x(n) to envelope followers 322, 324, 326 (collectively referred to as “the envelope followers”). Envelope followers 322, 324, 326 may analyze, or measure, the amplitudes, or envelopes, of the filtered signal x(n). The envelope followers may be configured with one or more time resolutions, or time constants. Each time constant may correspond to an attack time, decay, and/or a release time. The envelope followers may be configured with equivalent time constants that correspond to an equivalent attack time, decay, and release time. The envelope followers may be configured with time constants that are different, and, thus, correspond to different attack times, different decays, and different release times. The envelope followers may be configured with time constants that correspond to an attack time of any duration, such as 0.1, 1, 10, 100, or 1,000 milliseconds (ms) (or any other value). The envelope followers may be configured with time constants that correspond to a release time of 0.1, 1, 10, 100, 1,000, or 5,000 ms (or any other value). The envelope followers may be configured with time constants that correspond to a decay rate of any duration, such as 0.1, 1, 10, 100, or 1,000 ms (or any other value). The envelope followers may operate according to any number and/or combination of methods of envelope followers, including single-pole averagers, moving averagers, frame-by-frame averagers, or peak-hold algorithms.

As has been discussed, the envelope followers may be configured to generate one or more amplitude measurements of signal x(n). The amplitude measurements may represent one or more values, such as, for example, the instantaneous signal input level, a weighted average level, and/or noise floor level of signal x(n). Detector 302 may be configured to compare the difference in amplitudes of the instantaneous signal input and a noise floor level. Detector 302 may generate an indication 334 which may be based on a comparison of the measurements of instantaneous signal input level (which may be generated by envelope follower 322) and a weighted average level (which may be generated by envelope follower 324) to, for example, a loudness threshold. The loudness threshold may be a value represented as, for example, dB. The loudness threshold may be used to compare the respective envelopes generated by envelope followers 322, 324, which themselves may be generated according to a number of different decay and/or release times. Detector 302 may generate an indication 336 that may be based on a comparison of the measurements of instantaneous signal input level (envelope follower 322) and the noise floor level (envelope follower 326) to, for example, an activity threshold. The activity threshold may be a value represented as, for example, decibels (dB), decibels relative to full scale (dBFS), decibel Volt (dBV), or sound pressure level (dB SPL), and may generally signify a user is speaking and that the input signal is not due to inactivity of the microphone.

The loudness threshold and/or the activity threshold may be updated at various frequencies, such as, for example, dynamically (e.g., in real-time) or according to any number of periodic frequencies. The loudness threshold and/or the activity threshold may be fixed. The loudness threshold and/or activity threshold may be stored in, for example, database 208.

The envelope followers may convert the amplitude measurements to a value, for example, represented by decibels (dB), decibels relative to full scale (dBFS), decibel Volt (dBV), or sound pressure level (dB SPL), and may output one or more values to comparators 328 and/or 329. The output of the envelope followers may be linear or logarithmic.

In an example, envelope followers 322, 324 may output amplitude measurements to comparator 328 which may be represented as dB or dBFS. Comparator 328 may subtract the value of the amplitude measurement by envelope follower 324 from that of envelope follower 322 to obtain a value that may represent the relationship between the respective amplitude envelopes generated by envelope followers 324 and 322 (hereinafter generally referred to as an “amplitude relationship”). Comparator 328 may output the amplitude relationship to comparator 330. In other words, comparator 328 may output a value that represents, for example, the difference between the amplitude measurements of envelope followers 322, 324. Envelope followers 322, 326 may output amplitude measurements to comparator 329 which may be represented as dB or dBFS. Comparator 329 may subtract the value of the amplitude measurement by envelope follower 326 from that of envelope follower 322 to obtain another amplitude relationship. In other words, comparator 329 may output a value that represents, for example, the difference between the amplitude measurements of envelope followers 322, 326. Comparator 329 may output the value of the amplitude relationship to comparator 332. While the above disclosure generally describes the operations of comparators 328, 329 where the envelope followers are configured as logarithmic envelope followers, it is understood that comparators 328, 329 may operate with mathematically equivalent behavior where the envelope followers may be configured as linear envelope followers. That is, where reference is made to subtracting one value of an amplitude measurement from that of another (e.g., in the logarithmic domain), it is understood that linear envelope followers would perform division in the linear domain.

Comparators 330, 332 may utilize the amplitude relationship values from comparators 328, 329, respectively, to generate indications 334, 336, respectively. Comparators 330, 332 may generate indications 334, 336 by comparing the amplitude relationship values from comparators 328, 329, respectively, to one or more thresholds. Comparator 330 may compare the amplitude relationship value output from comparator 328 to, for example, a loudness threshold. If the amplitude relationship value output from comparator 328 is greater than the loudness threshold, comparator 330 may generate indication 334 (e.g., indication 334 is “true” or has a value corresponding to “1”). Comparator 332 may compare the amplitude relationship value output from comparator 329 to, for example, an activity threshold. If the amplitude relationship value is greater than the activity threshold, comparator 332 may generate indication 336. Based on the state of indications 334, 336, comparator 305 may determine whether to issue an instruction for target gain calculation module 306 to recalculate the target gain for the system and/or an instruction for update module 308 to adjust the gain state of the system toward the incumbent target gain value. For example, as discussed above, if indication 336 is “true” (e.g., amplitude relationship value output from comparator 329 is greater than activity threshold) (e.g., value corresponding to “1”), this may indicate that a user is speaking and may instruct gain state update module 308 to adjust the gain state towards the incumbent target gain. If both indication 334 and indication 336 are “true,” target gain calculation module 306 may be instructed to recalculate the target gain of the audio system and to adjust the gain state towards the recalculated target gain. If indication 336 is “true,” but indication 334 is “false” (e.g., amplitude relationship value output from comparator 328 is less than loudness threshold) (e.g., value corresponding to “0”), gain state update module 308 may be instructed to adjust the gain state of the system toward the incumbent target gain without recalculating the target gain of the system.

Gain control module 200 may include frame-by-frame averagers (not shown) configured to perform frame-by-frame amplitude detection of an audio signal, such as signal x(n). One or more frame averagers may be configured to capture a root mean square (RMS), peak, and/or other measure of a frame of the audio signal. The frame may be any size, or duration. Frame-by-frame averagers may employ any number of measuring algorithms, such as linear-scaled algorithms, logarithmic-scaled algorithms, and/or algorithms formatted with other scaling. The frame-by-frame averagers may output to comparators 330 and/or 332. Comparators 330 and/or 332 may utilize one or more of these measurements to determine the values of indications 334, 336, respectively, according to aspects described herein.

FIG. 3c illustrates an example input/output (“I/O”) curve 350 (hereinafter referred to as “curve 350”) that may represent one of many I/O curves of target gain calculation module 306. Target gain calculation module 306 may be configured to implement curve 350 to calculate the target gain. The structure of curve 350 may be chosen to help reduce the impact of background noise, such as, for example, background noise coming from background talkers. Curve 350 may be configured to help configure a gain I/O curve that might not be hardware dependent (i.e., dependent on the particular microphone) and may help enable consistent performance over a wide range of microphone types. Curve 350 may be modeled as a function of signal input level versus signal output level. The signal output level may reflect an expanded or limited signal level. The signal input level and signal output level may both be represented as values comparable to, for example, decibels relative to full scale (dBFS).

Line 360 represents a desired output level. Line 362 represents equivalence between the output level and the input level. In other words, line 362 represents instances when 0 dB of gain is applied to the signal. Target gain calculation module 306 may determine target gain by measuring the difference between curve 350 and line 362. For example, when curve 350 is above line 362, the calculated target gain to reach desired output level 360 is positive (in decibels). When curve 350 falls below line 362, the calculated target gain to reach desired output level 360 is negative (in decibels).

Curve 350 may include multiple states, for example, that may be represented by regions 352, 354, 356. Region 352 may correspond to, for example, an expansion region. If the signal input level falls within region 352, target gain calculation module 306 may expand the signal output to a predetermined level, as reflected by segment 352a. Region 354 may correspond to, for example, a max boost region. If the signal input level falls within region 354, target gain calculation module 306 may boost the signal output by a maximum predetermined gain, as reflected by segment 354a. Region 356 may correspond to, for example, a match desired level region. If the input signal level falls within region 356, target gain calculation module 306 may calculate a target gain to achieve desired output level. Segments 352a and/or 356a may be linear or curved (when represented in the logarithmic domain). Segment 354a may be linear (when represented in the logarithmic domain). Segment 354a may be parallel with line 362. Segment 356a may represent an equivalent value (in dBFS) as that of line 360. Curve 350 may be segmented into fewer or more divisions, or regions, than regions 352, 354, 356. Segment 352a may have a steeper slope than that of segment 354a, which may in turn have a steeper slope than that of segment 356a.

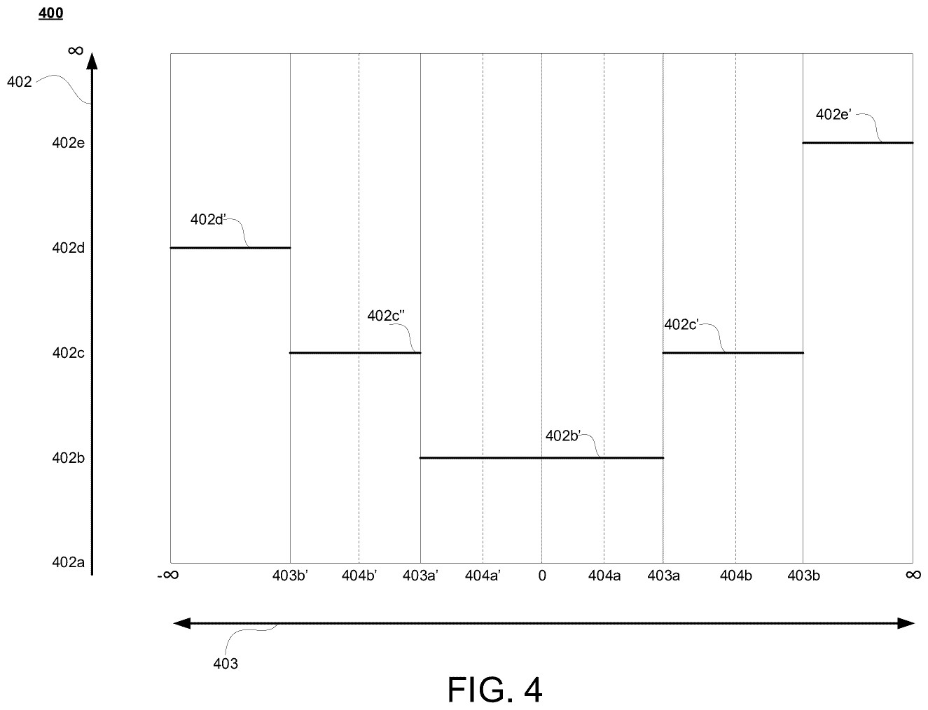

FIG. 4 illustrates an example hysteresis gain ramp speed plot 400 (hereinafter referred to as “plot 400”) that update module 308 may implement to determine the rate, or speed, at which, if necessary, to increase or decrease the gain state of the system until it reaches either an incumbent or a recalculated target gain. Plot 400 may be implemented as or incorporated into, for example, software executable by, for example, processor 204, firmware, and/or a combination thereof. Update module 308 may utilize plot 400 to adjust the gain of the system (to the extent adjustment is required) in order to reach a calculated target gain. Plot 400 may be represented as a function of ramp speed (line 402), versus difference between the gain state of the system and target gain (line 403).

Elements 402a and 402b-402c (and corresponding lines 402b′, 402c′, 402c″, 402d′, 402e′, respectively) of line 402 may denote different ramp speed (or rate) values represented as, for example, decibels per second (dB/Sec), ranging from, for example, zero (402a) to infinity. Lines 402a-402e may generally represent, in an increasing manner, various durations of time it takes to increase (or decrease, as the case may be) the gain state of the system to match an incumbent or calculated target gain. Plot 400 may include fewer or more than lines 402a-402c. In other words, line 402 of plot 400 may be segmented in any number of divisions from zero to infinity. Element 402b and line 402b′ may represent, for example, a standard, or default, ramp speed. Element 402c and lines 402c′, 402c″ may represent, for example, a ramp speed with a greater value in, for example, dB/Sec, than element 402b and line 402b′. Element 402d and line 402d′ may represent, for example, a ramp speed with a greater value in, for example, dB/Sec, than element 402c and lines 402c′, 402c″, and may correspond to conditions in which a high increase rate is utilized. Element 402e and line 402e′ may represent, for example a ramp speed with a greater value in, for example, dB/Sec, than element 402d and line 402d′, and may correspond to conditions in which a high decrease rate is utilized. In other words, the greater the difference between the gain state of the system and the target gain in the negative direction (i.e., from zero towards negative infinity), the greater the value of the increase rate may be. The greater the difference between the gain state of the system and the target gain in the positive direction (i.e., from zero towards infinity), the greater the value of the decrease rate may be.

Lines 403a, 403a′, 403b, 403b′, 404a, 404a′, 404b, 404b′ may represent various differences (or distances) between the gain state of the system, such as the gain applied to signal x(n), and a calculated target gain, represented as, for example, decibels (dB), ranging from, for example, negative infinity to zero to infinity. Plot 400 may include fewer or more than lines 403a, 403a′, 403b, 403b′, 404a, 404a′, 404b, 404b′. In other words, line 403 of plot 400 may be segmented into any number of divisions from negative infinity to infinity.

Lines 403a, 403a′, 403b, 403b′ may represent gain difference thresholds. Lines 404a, 404a′, 404b, 404b′ may represent convergence thresholds. Plot 400 may include any number of gain difference thresholds and/or convergence thresholds. In operation, when the difference between the gain state and calculated gain exceeds a gain difference threshold with an increasing magnitude of difference, update module 308 may adjust the ramp rate based on corresponding lines 402b′, 402c′, 402c″, 402d′, and 402e′. Update module 308 may return to the previous ramp rate when the magnitude of difference between the gain state and calculated gain decreases to less than the corresponding convergence threshold 404a, 404a′, 404b, 404b′.

In operation, update module 308 may measure an initial difference between the gain state of the system and the target gain and apply an appropriate ramp rate. Update module 308 may apply a given ramp rate 402a, 402b, 402c, 402d, 402e until either 1) the magnitude of the difference decreases below the next convergence threshold that is less than the absolute of the gain difference threshold; or 2) the magnitude of the difference increases to the point of exceeding the next gain difference threshold.

For example, if the initial difference falls between zero and gain difference threshold 403a, update module 308 may apply ramp rate 402b′. Update module 308 may continuously measure the difference between the gain state of the system and the target gain. Update module 308 may measure the difference between the gain state of the system and the target gain at any number of frequencies and/or intervals, such as, for example, at various time intervals (e.g., 1 ms, 10 ms, 50 ms, 100 ms, 500 ms, 1000 ms, 10,000 ms, etc.), or continuously. If, for example, update module 308 re-measures the difference, and the new difference exceeds the gain difference threshold 403a but does not exceed gain difference threshold 403b, update module 308 may apply ramp rate 402c′. If, for example, update module 308 re-measures the difference, and the new difference exceeds convergence threshold 404b but does not exceed gain difference threshold 403b, update module 308 will not apply a new ramp rate (i.e., update module 308 may continue to apply ramp rate 402c′).

If, for example, update module 308 re-measures the difference, and the new difference exceeds gain difference threshold 403b, update module 308 may apply ramp rate 402e′. After update module 308 re-measures the difference, if the new difference is less than gain difference threshold 403b but is still greater than convergence threshold 404b, update module will not change the ramp rate. After update module 308 re-measures the difference, if the new difference is less than convergence threshold 404b but greater than convergence threshold 404a, update module 308 may change the ramp rate to ramp rate 402c′. After update module 308 re-measures the difference, if the new difference is less than gain difference threshold 403a but is still greater than convergence threshold 404a, update module will not apply a new ramp rate (i.e., update module 308 may continue to apply ramp rate 402c′). After update module 308 re-measures the difference, if the new difference is less than convergence threshold 404a and greater than 0, update module 308 may apply ramp rate 402b′. After update module 308 re-measures the difference, if the new difference exceeds convergence threshold 404a but does not exceed gain difference threshold 403a, update module 308 might not apply a new ramp rate (i.e., update module 308 may continue to apply ramp rate 402b′).

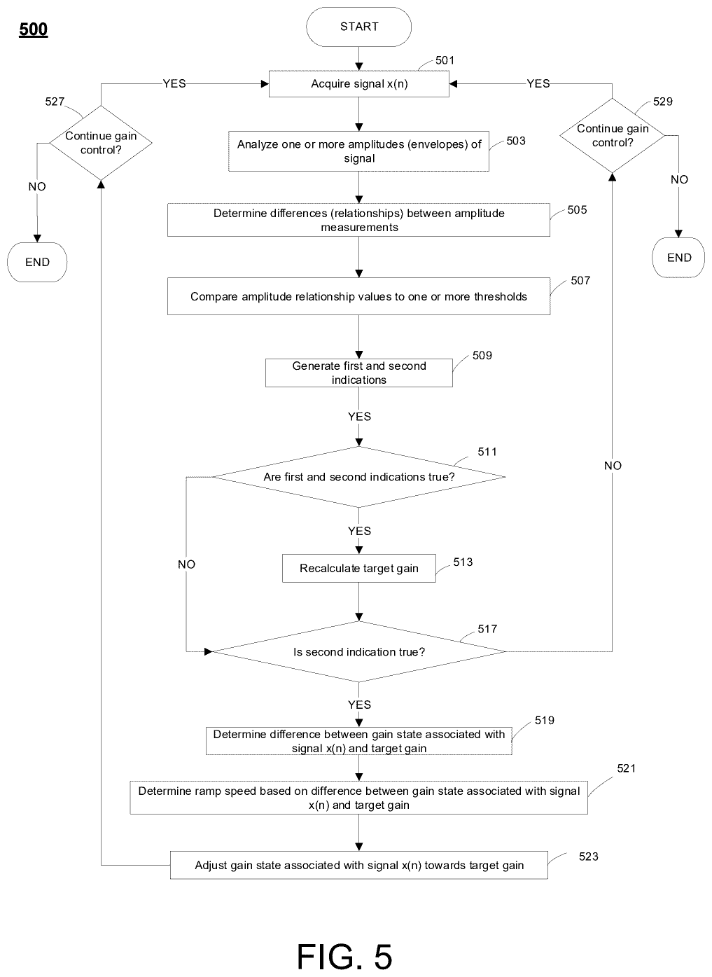

FIG. 5 illustrates an example flow chart of a method 500 that may be performed to implement one or more illustrative aspects described herein. Some or all of the steps may be performed by gain control module 200 housed in, for example, device 100. Additionally, or alternatively, some or all of the steps may be performed by gain control module 200 housed in a device connected to device 100 (such as devices 102, 104, 106, and/or other devices operating a software application capable of performing the operations described herein). Some or all of the steps may be performed by firmware applications intended to run without an operating system, such as, for example, an application specific integrated circuit (ASIC), or a digital signal processing (DSP) chip configured to perform the operations described herein natively or by the control of an operating system, etc. While the method shows particular steps in a particular order, the method may be further subdivided into additional sub-steps, steps may be combined, the steps may be performed in other orders, and some steps may be omitted without necessarily deviating from the concepts described herein.

In operation, detector 302 may receive an audio signal x(n) from an input device, such as device 100. (step 501, FIG. 5). The audio signal may be generated by, for example, a user speaking into device 100. Envelope followers 322, 324, 326 may analyze the signal amplitudes (or envelopes) according to aspects described herein (step 503). Comparators 328, 329 may respectively determine differences (or relationships) between amplitude measurements, such as, for example, the differences between amplitude measurements generated by envelope followers 322, 324 and between those generated by envelope followers 322, 326 (step 505). Comparators 330, 332 may compare the amplitude relationship values output by comparators 328, 329, respectively, to one or more thresholds as discussed herein (step 507). Comparators 330, 332 may generate indications 334, 336, respectively, and output them to comparator 305 (step 509). Comparator 305 may be configured to receive one or more of indications 334, 336 from comparators 330, 332, respectively, and generate an output to target gain calculation module 306 based on the state of one or more of indications 334, 336. If indications 334, 336 are “true” (step 511: YES), target gain calculation module 306 may recalculate the target gain of the audio system according to aspects described herein (step 513). In an example, target gain calculation module 306 may recalculate the target gain of the audio system according to aspects described herein if indication 334 is “true.” Processor 204 may instruct update module 308 to determine the difference (or distance) between the gain state of the system and the incumbent or recalculated target gain (step 519). Update module 308 may determine, based on the difference (or distance) between the gain state of the system and the incumbent (or recalculated) target gain, the appropriate ramp speed by which to increase or decrease the gain state of the system to meet the incumbent (or recalculated) target gain as described herein (step 521). Update module 308 may utilize methods such as, for example, plot 400, to determine the appropriate ramp speed. Update module 308 may adjust the signal gain at a given ramp speed as described herein, to meet the incumbent or recalculated target gain (step 523). Gain control module 200 may receive instructions to automatically continue steps 501 through 523 (step 527: YES) for an indefinite number of iterations or to automatically continue steps 501 through 523 for a set number of iterations. In an example, gain control module 200 may receive instructions to terminate the procedure 500 (step 527: NO).

If one of indications 334, 336 is “false” (step 511: NO), but indication 336 is “true” (step 517: YES), processor 204 may instruct update module 308 to perform step 519 as described above. Update module 308 may perform steps 521 and 523 as described above. Update module 308 may utilize methods such as, for example, plot 400, to determine the appropriate ramp speed. Gain control module 200 may receive instructions to automatically continue steps 501 through 523 (step 527: YES) for an indefinite number of iterations or to automatically continue steps 501 through 523 for a set number of iterations. In an example, gain control module 200 may receive instructions to terminate the procedure 500 (step 527: NO).

If neither the first nor the second amplitude relationships satisfy respective threshold values (i.e., neither indications 334 nor 336 are “true”), processor 204 may instruct automatic gain control module 200 to maintain the current gain state of the system (step 517: NO). Gain control module 200 may receive instructions to automatically continue steps 501 through 523 (step 529: YES) for an indefinite number of iterations or to automatically continue steps 501 through 523 for a set number of iterations. In an example, gain control module 200 may receive instructions to terminate the procedure 500 (step 529: NO).

Any of the circuitry in FIGS. 3a-3b may be implemented as or incorporated into, for example, as a microcontroller, a programmable gate array (PGA), as a MOS integrated circuit (IC) chip, an ASIC, a DSP chip configured to perform the operations described herein natively or by the control of an operating system, a complex programmable logic device (CPLD), an FPGA chip, or an analog electrical circuit. The ASIC could contain a transistor, such as a FET. Any of the operations described herein may be implemented with hardware, software executable by, for example, processor 204, firmware, and/or a combination thereof.

The aspects described herein may be performed by a number of devices and/or device configurations. The aspects describe herein may be performed by device 100. No other equipment might be necessary to perform the operations described herein. A user may connect device 100 to devices 102, 104, 106, and/or other devices operating a software application capable of performing the operations described herein. Some or all of the components of FIGS. 3a-3c, 4, and 6 may be logical blocks implemented as embedded software running in, for example, device 100 and/or other devices operating a software application capable of performing operations described herein, and may be executable by processor 204. The aspects described herein may be performed by firmware applications intended to run without an operating system, such as, for example, an ASIC, or a DSP chip configured to perform the operations described herein natively or by the control of an operating system, etc. In an example, the aspects described herein can be performed by a smartphone, desktop computer, laptop computer, and/or other devices that may or might not have an internal microphone and/or a software application capable of performing the operations described herein. No other audio equipment might be necessary to perform the operations described herein.

FIG. 6 illustrates an example block diagram whereby one or more input devices 100, 600, 602, and 604 may be connected to gain control module modules 200a, 200b, 200c, and 200n, respectively, operating in concert with auto-mixer 605. Gain control modules 200a, 200b, 200c, and 200n (collectively referred to as “the gain control modules”) may operate in accordance with concepts described herein. The input devices may include device 100 and microphones 600, 602, 604. Microphones 600, 602, 604 may include any number of microphone types, including a condenser microphone (including large-and small-diaphragm and electret condenser), a dynamic microphone (including moving coil and ribbon microphones), a MEMS microphone, etc. The input devices may include more or fewer microphones. The input devices may connect to the gain control modules using any one of a variety of different connectors, including a LEMO connector, an XLR connector, a TQG connector, a TRS connector, a USB connector, or RCA connectors. The input devices may be wireless and connect to the gain control modules through any one of a variety of protocols, including WiMAX, LTE, Bluetooth, Bluetooth Broadcast, GSM, 3G, 4G, 5G, 6G, Zigbee, 60 GHz Wi-Fi, Wi-Fi (e.g., compatible with IEEE 802.11a/b/g/n/ac/ad/af/ah/ai/aj/aq/ax/ay/ba/be), NFC protocols, proprietary wireless connection protocols, and/or any other protocol. Where the connection is wireless, the input devices (and/or their respective transmitters, receivers, or transceivers) and the gain control modules may include a wireless communications interface. The gain control modules may be compatible with any number and type of output devices, such as output device 606. Output device 606 may receive an output signal, such as signal y(n), from gain control module modules 200a-200n for playback, transmittal to another external device, or for further processing. Output device 606 may include, for example, loudspeakers or other audio output devices, an audio mixer, a wireless transmitter, receiver, transceiver, etc.

As illustrated above with respect to FIG. 6, gain control module 200 may be compatible with any number and type of input devices, such as microphones. The gain control modules may be configured to operate in concert with auto-mixer 605. The gain control modules may be equivalent in structure and operation to gain control module 200. When the gain control modules are utilized with multiple microphones simultaneously and used in combination with auto-mixer 605, it may be advantageous to estimate the overall effective sensitivity of input devices 100, 600, 602, 604, so that an equal acoustic sound intensity may be detected equally by each channel of auto-mixer 605. The gain control modules may be communicatively connected to sensitivity offset controller 608 (hereinafter referred to as “offset controller 608”). Offset controller 608 may be configured to receive respective audio signals x(n) from devices 100, 600, 602, 604; respective outputs from respective envelope followers 326 of the gain control modules; and respective indications 336 from respective comparators 332 of the gain control modules.

Offset controller 608 may be configured to equalize the effective acoustic sensitivity of each respective signal x(n) of each input device 100, 600, 602, 604. Offset controller 608 may be configured to output respective modified audio signals s(n), equalized for sensitivity, as a secondary input into auto-mixer 605.

For example, if there is a significant difference among the estimated noise floors of the signal levels of input devices 100, 600, 602, 604, it may be advantageous to apply an offset gain to one or more of the signal levels to equalize the effective acoustic sensitivity of each input device 100, 600, 602, 604. Assuming that acoustic noise (as opposed to electrical noise) is the dominant component of the noise floor of each input, the respective envelope followers of the gain control modules and offset controller 608 may be used to estimate the effective sensitivity of each input device 100, 600, 602, 604. That is, for example, where input devices 100, 600, 602, 604 are microphones, the acoustic noise component of the noise floor of each input may refer to the combination of the physical sensitivity of the respective microphone transducers (from acoustic pressure to electrical signal) and any gain that may be applied (either in the analog or digital domain) before being input into gain control subsystem 304.

The gain control modules may generate indications 336 for each respective input signal of input devices 100, 600, 602, 604, according to aspects described herein. If the respective indications 336 are “false” for all input devices, offset controller 608 and the respective envelope followers 326 for each of the gain control modules may estimate the acoustic noise floor of each input device 100, 600, 602, 604. Offset controller 608 may determine the maximum (or minimum) measurement generated by each respective envelope follower 326. Offset controller 608 may determine the difference in noise floor amplitude between each input and the maximum (or minimum) measurement of the entire set of envelope followers 326. Offset controller 608 may apply the difference as an offset gain to each respective signal x(n) for each input device 100, 600, 602, 604. If any of the respective indications 336 are “true,” sensitivity controller 608 might not apply a new offset gain and may apply the existing offset gain. If starting from an initial condition, for example, offset controller 608 may apply a gain of 0 dB. Offset controller 608 may be configured to output modified signals s(n), equalized for sensitivity, as a secondary input to auto-mixer 605.

An apparatus may comprise one or more features. The apparatus may comprise an audio detector and/or a gain control system. The audio detector may be configured to receive a first audio signal. The audio detector may comprise a first envelope follower configured to generate, from a first audio signal and based on a first time constant, a first amplitude measurement. The audio detector may comprise a second envelope follower configured to generate, from the first audio signal and based on a second time constant different from the first time constant, a second amplitude measurement. The audio detector may comprise a first comparator configured to output a first difference between the first amplitude measurement and the second amplitude measurement. The audio detector may comprise a second comparator configured to generate a first indication of whether the first difference satisfies a first threshold value. The gain control subsystem may comprise a target gain calculation module configured to calculate, based on the first indication, a target gain for the first audio signal. The gain control subsystem may comprise a gain state update module configured to modify, based on the target gain, a gain state associated with the first audio signal. The audio detector may further comprise a third envelope follower configured to generate, from the first audio signal and based on a third time constant different from the first time constant and second time constant, a third amplitude measurement. The audio detector may further comprise a third comparator configured to output a second difference between the first amplitude measurement and the third amplitude measurement. The audio detector may further comprise a fourth comparator configured to generate a second indication of whether the second difference satisfies a second threshold value. The gain state update module may be further configured to modify, based on the second indication, the gain state associated with the first audio signal. The gain control subsystem may further comprise a fifth comparator configured to output, based at least on the first indication and the second indication, a third indication comprising at least one of: 1) whether to calculate a target gain for the first audio signal; or 2) whether to modify, based on the target gain, the gain state associated with the first audio signal. The gain state update module may be configured to modify the gain state associated with the first audio signal based on a hysteresis of the gain state associated with the first audio signal. The gain state associated with the first audio signal may be modified according to a ramp speed, the ramp speed based on a difference between the target gain and the gain state associated with the first audio signal. At least one of the first envelope follower, the second envelope follower, or the third envelope follower may be configured to measure a first noise floor of the first audio signal. The audio detector may further comprise a fourth envelope follower configured to generate a fourth amplitude measurement of a second noise floor of a second audio signal. The apparatus may further comprise a sensitivity offset controller. The third comparator may be further configured to measure a third difference between the fourth amplitude measurement and the third amplitude measurement. The sensitivity offset controller may be configured to: generate an offset gain based on the third difference; and apply the offset gain to at least one of the first audio signal or the second audio signal. The apparatus may further comprise at least one of a wireless transmitter, a wireless receiver, a wireless transceiver, or a microphone.

A non-transitory machine-readable storage medium may comprise instructions which, when executed by one or more processors, may cause the one or more processors to perform one or more operations. The one or more operations may comprise generating, from a first audio signal and based on a first time constant, a first amplitude measurement. The one or more operations may comprise generating, from the first audio signal and based on a second time constant different from the first time constant, a second amplitude measurement. The one or more operations may comprise outputting a first difference between the first amplitude measurement and the second amplitude measurement. The one or more operations may comprise generating a first indication of whether the first difference satisfies a first threshold value. The one or more operations may comprise calculating, based on the first indication, a target gain for the first audio signal. The one or more operations may comprise modifying, based on the target gain, a gain state associated with the first audio signal. The one or more operations may comprise generating, from the first audio signal and based on a third time constant different from the first time constant and second time constant, a third amplitude measurement. The one or more operations may comprise outputting a second difference between the first amplitude measurement and the third amplitude measurement. The one or more operations may comprise generating a second indication of whether the second difference satisfies a second threshold value. The one or more operations may comprise modifying, based on the second indication, the gain state associated with the first audio signal. The one or more operations may comprise outputting, based at least on the first indication and the second indication, a third indication comprising at least one of: 1) whether to calculate a target gain for the first audio signal; or 2) whether to modify, based on the target gain, the gain state associated with the first audio signal. The one or more operations may comprise modifying the gain state associated with the first audio signal based on a hysteresis of the gain state. The one or more operations may comprise modifying the gain state associated with the first audio signal according to a ramp speed, wherein the ramp speed is based on a difference between the target gain and the gain state. The one or more operations may comprise generating, from a second audio signal, a fourth amplitude measurement. The one or more operations may comprise outputting a third difference between the fourth amplitude measurement and the third amplitude measurement. The one or more operations may comprise generating an offset gain based on the third difference. The one or more operations may comprise applying the offset gain to at least one of the first audio signal or the second audio signal.

A method may comprise one or more operations. The method may comprise generating, by a computing device, a first amplitude measurement of a first audio signal and based on a first time constant. The method may comprise generating, from the first audio signal and based on a second time constant different from the first time constant, a second amplitude measurement. The method may comprise outputting a first difference between the first amplitude measurement and the second amplitude measurement. The method may comprise generating a first indication of whether the first difference satisfies a first threshold value. The method may comprise calculating, based on the first indication, a target gain for the first audio signal. The method may comprise modifying, based on the target gain, a gain state associated with the first audio signal. The method may comprise generating, from the first audio signal and based on a third time constant different from the first time constant and second time constant, a third amplitude measurement. The method may comprise outputting a second difference between the first amplitude measurement and the third amplitude measurement. The method may comprise generating a second indication of whether the second difference satisfies a second threshold value. The method may comprise modifying, based on the second indication, the gain state associated with the first audio signal. The method may further comprise: generating, from a second audio signal, a fourth amplitude measurement; outputting a third difference between the fourth amplitude measurement and the third amplitude measurement; generating an offset gain based on the third difference; and/or applying the offset gain to at least one of the first audio signal or the second audio signal. The modifying may further comprise modifying the gain state associated with the first audio signal based on a hysteresis of the gain state associated with the first audio signal. The modifying may further comprise modifying the gain state associated with the first audio signal according to a ramp speed, wherein the ramp speed is based on a difference between the target gain and the gain state associated with the first audio signal. The method may be performed by an apparatus described herein. A system may comprise the apparatus and one or more other elements described herein.

In the foregoing specification, the present disclosure has been described with reference to specific exemplary examples thereof. Although the invention has been described in terms of a preferred example, those skilled in the art will recognize that various modifications, examples or variations of the invention can be practiced within the spirit and scope of the invention as set forth in the appended claims. The specification and drawings are, therefore, to be regarded in an illustrative rather than restrictive sense. Accordingly, it is not intended that the invention be limited except as may be necessary in view of the appended claims.

1. An apparatus comprising:
an audio detector configured to receive a first audio signal, wherein the audio detector comprises:
a first envelope follower configured to generate, from a first audio signal and based on a first time constant, a first amplitude measurement;
a second envelope follower configured to generate, from the first audio signal and based on a second time constant different from the first time constant, a second amplitude measurement;
a first comparator configured to output a first difference between the first amplitude measurement and the second amplitude measurement; and
a second comparator configured to generate a first indication of whether the first difference satisfies a first threshold value; and
a gain control subsystem comprising:
a target gain calculation module configured to calculate, based on the first indication, a target gain for the first audio signal; and
a gain state update module configured to modify, based on the target gain, a gain state associated with the first audio signal.

2. The apparatus of claim 1, wherein:
the audio detector further comprises:
a third envelope follower configured to generate, from the first audio signal and based on a third time constant different from the first time constant and second time constant, a third amplitude measurement;
a third comparator configured to output a second difference between the first amplitude measurement and the third amplitude measurement; and
a fourth comparator configured to generate a second indication of whether the second difference satisfies a second threshold value; and
wherein the gain state update module is further configured to modify, based on the second indication, the gain state associated with the first audio signal.

3. The apparatus of claim 2, wherein the gain control subsystem further comprises a fifth comparator configured to output, based at least on the first indication and the second indication, a third indication comprising at least one of:
whether to calculate a target gain for the first audio signal; or
whether to modify, based on the target gain, the gain state associated with the first audio signal.

4. The apparatus of claim 2, wherein at least one of the first envelope follower, the second envelope follower, or the third envelope follower is configured to measure a first noise floor of the first audio signal.

5. The apparatus of claim 4, wherein the audio detector further comprises a fourth envelope follower configured to generate a fourth amplitude measurement of a second noise floor of a second audio signal.

6. The apparatus of claim 5, further comprising a sensitivity offset controller, wherein:
the third comparator is further configured to:
measure a third difference between the fourth amplitude measurement and the third amplitude measurement; and
the sensitivity offset controller is configured to:
generate an offset gain based on the third difference; and
apply the offset gain to at least one of the first audio signal or the second audio signal.

7. The apparatus of claim 1, wherein the gain state update module is configured to modify the gain state associated with the first audio signal based on a hysteresis of the gain state associated with the first audio signal.

8. The apparatus of claim 7, wherein the gain state associated with the first audio signal is modified according to a ramp speed, and wherein the ramp speed is based on a difference between the target gain and the gain state associated with the first audio signal.

9. The apparatus of claim 1, further comprising at least one of a wireless transmitter, a wireless receiver, a wireless transceiver, or a microphone.

10. A non-transitory machine-readable storage medium comprising instructions that, when executed by one or more processors, cause the one or more processors to:
generate, from a first audio signal and based on a first time constant, a first amplitude measurement;
generate, from the first audio signal and based on a second time constant different from the first time constant, a second amplitude measurement;
output a first difference between the first amplitude measurement and the second amplitude measurement;
generate a first indication of whether the first difference satisfies a first threshold value;
calculate, based on the first indication, a target gain for the first audio signal; and
modify, based on the target gain, a gain state associated with the first audio signal.

11. The non-transitory machine-readable storage medium of claim 10, wherein the instructions, when executed by the one or more processors, further cause the one or more processors to:
generate, from the first audio signal and based on a third time constant different from the first time constant and second time constant, a third amplitude measurement;
output a second difference between the first amplitude measurement and the third amplitude measurement;
generate a second indication of whether the second difference satisfies a second threshold value; and
modify, based on the second indication, the gain state associated with the first audio signal.

12. The non-transitory machine-readable storage medium of claim 11, wherein the instructions, when executed by the one or more processors, further cause the one or more processors to output, based at least on the first indication and the second indication, a third indication comprising at least one of:
whether to calculate a target gain for the first audio signal; or
whether to modify, based on the target gain, the gain state associated with the first audio signal.

13. The non-transitory machine-readable storage medium of claim 11, wherein the instructions, when executed by the one or more processors, further cause the one or more processors to:
generate, from a second audio signal, a fourth amplitude measurement;
output a third difference between the fourth amplitude measurement and the third amplitude measurement;
generate an offset gain based on the third difference; and
apply the offset gain to at least one of the first audio signal or the second audio signal.

14. The non-transitory machine-readable storage medium of claim 10, wherein the instructions, when executed by the one or more processors, further cause the one or more processors to modify the gain state associated with the first audio signal based on a hysteresis of the gain state.

15. The non-transitory machine-readable storage medium of claim 14, wherein the instructions, when executed by the one or more processors, further cause the one or more processors to modify the gain state associated with the first audio signal according to a ramp speed, wherein the ramp speed is based on a difference between the target gain and the gain state.

16. A method comprising:
generating, by a computing device, a first amplitude measurement of a first audio signal and based on a first time constant;
generating, from the first audio signal and based on a second time constant different from the first time constant, a second amplitude measurement;
outputting a first difference between the first amplitude measurement and the second amplitude measurement;
generating a first indication of whether the first difference satisfies a first threshold value;
calculating, based on the first indication, a target gain for the first audio signal; and
modifying, based on the target gain, a gain state associated with the first audio signal.

17. The method of claim 16, further comprising:
generating, from the first audio signal and based on a third time constant different from the first time constant and second time constant, a third amplitude measurement;
outputting a second difference between the first amplitude measurement and the third amplitude measurement; and
generating a second indication of whether the second difference satisfies a second threshold value; and
modifying, based on the second indication, the gain state associated with the first audio signal.

18. The method of claim 17, further comprising:
generating, from a second audio signal, a fourth amplitude measurement;
outputting a third difference between the fourth amplitude measurement and the third amplitude measurement;
generating an offset gain based on the third difference; and
applying the offset gain to at least one of the first audio signal or the second audio signal.

19. The method of claim 16, wherein the modifying further comprises modifying the gain state associated with the first audio signal based on a hysteresis of the gain state associated with the first audio signal.

20. The method of claim 19, wherein the modifying further comprises modifying the gain state associated with the first audio signal according to a ramp speed, wherein the ramp speed is based on a difference between the target gain and the gain state associated with the first audio signal.
